(19) United States
(12) Patent Application Publication
(10) Pub. No.: US 2014/0152830 A1
(43) Pub. Date: Jun. 5, 2014

(54) MULTI-IMAGE PROCESSING APPARATUS

(71) Applicant: Jeonghun Lee, Seoul (KR)

(72) Inventor: Jeonghun Lee, Seoul (KR)

(73) Assignee: LG INNOTEK CO., LTD., Seoul (KR)

(21) Appl. No.: 14/234,603

(22) PCT Filed: Jul. 9, 2012
(86) PCT No.: PCT/KR2012/005427

§ 371 Date: Jan. 23, 2014

(30) Foreign Application Priority Data
Jul. 26, 2011 (KR) 10-2011-0074286

(51) Int. Cl. H04N 7/18

(52) U.S. Cl. CPC H04N 7/183
USPC 348/148

(57) ABSTRACT

The present invention relates to a multi-image processing apparatus. The multi-image processing apparatus is such that a subject is photographed by a camera to obtain an image, and the image is branched out and performed with respectively different image processes. According to the multi-image processing apparatus according to the present invention can reduce the number of cameras that are mounted.

### TECHNICAL FIELD

The teachings in accordance with exemplary embodiments of this invention relate generally to a multi-image processing apparatus.

### BACKGROUND ART

Generally, a camera is a device photographing a subject by being manufactured with an essential part including an image sensor such as a CCD (Charged Coupled Device) or a CMOS (Complementary Metal-Oxide Semiconductor). Recently, the camera is mounted on a variety of devices to provide multi-functions and promote convenience.

Particularly, a plurality of cameras is mounted on a front and a rear side of a vehicle to allow a driver to obtain a good view for safe driving, whereby the camera has taken a place as an important part for preventing occurrence of an accident. However, as the number of cameras mounted on a vehicle increase, problems arise as to where the cameras are to be mounted.

### DISCLOSURE OF INVENTION

### Technical Problem

The present general inventive concept is to provide a multi-image processing apparatus directed to solve the aforementioned problems or disadvantages by branching out an image of a subject captured by a single camera and providing the branched-out image to a plurality of processing units capable of performing mutually different image processes, thereby reducing the number of cameras.

Technical problems to be solved by the present invention are not restricted to the above-mentioned, and any other technical problems not mentioned so far will be clearly appreciated from the following description by skilled in the art. Additional aspects and advantages of the present general inventive concept will be set forth in part in the description which follows and, in part, will be obvious from the description, or may be learned by practice of the general inventive concept.

### Solution to Problem

According to a general aspect and an exemplary embodiment of the present invention, there is provided a multi-image processing apparatus, the apparatus comprising: a camera capturing a subject to obtain an image; and a plurality of processing units receiving the image from the camera to respectively perform an image processing operation.

Preferably, but not necessarily, the apparatus further comprises a first pre-processing unit receiving the image from the camera to physically process the image.

Preferably, but not necessarily, at least one or more processing units in the plurality of processing units receive the image physically processed by the first pre-processing unit.

Preferably, but not necessarily, the physical process of the image performed by the first pre-processing unit includes one of enlargement, reduction and cutting of the image received from the camera.

Preferably, but not necessarily, the apparatus further comprises a second pre-processing unit receiving the image from the camera to extract an image attribute from the image.

Preferably, but not necessarily, at least one or more processing units in the plurality of processing units receive an attribute-extracted image from the second pre-processing unit.

Preferably, but not necessarily, the apparatus further comprises a first storage storing a data related to the image attribute, and a first controller controlling the second pre-processing unit by comparing the image attribute extracted by the second pre-processing unit with a data related to an attribute stored in the first storage.

Preferably, but not necessarily, the extraction of image attribute includes at least one of brightness detection of the image, detection of an operating object, extraction of password and detection of speed of the object.

Preferably, but not necessarily, the apparatus further comprises a second storage storing a synthetic element synthesizable with the image received from the camera, and a synthesizer synthesizing the image received from the camera with the synthetic element stored in the second storage.

Preferably, but not necessarily, at least one or more processing units in the plurality of processing units receive the image synthesized by the synthesizer.

Preferably, but not necessarily, the apparatus further comprises a second controller controlling the synthesizer to synthesize the synthetic element stored in the second storage with the image received from the camera.

Preferably, but not necessarily, the camera and the plurality of processing units are mounted on a vehicle.

### Advantageous Effects of Invention

A multi-image processing apparatus according to an exemplary embodiment of the present invention has an advantageous effect in that an image of a subject captured by a single camera is branched out to be provided to a plurality of processing units capable of performing mutually different image processing, whereby the number of cameras can be reduced.

Another advantageous effect is that a single camera can be installed at a device needing several cameras to enable miniaturization of the device and reduction in cost, whereby power consumption can be reduced and wiring can be simplified.

### BRIEF DESCRIPTION OF DRAWINGS

The teachings of the present invention can be readily understood by considering the following detailed description in conjunction with the accompanying drawings, in which:

FIG. 1 is a schematic block diagram illustrating a multi-image processing apparatus according to the present invention;

FIG. 2 is a schematic block diagram explaining a comparative example according to the present invention;

FIG. 3 is a schematic block diagram illustrating a multi-image processing apparatus according to an exemplary embodiment of the present invention;

FIG. 4 is a schematic view illustrating an image captured by a multi-image processing apparatus mounted on a vehicle according to the present invention;

FIG. 5 is a schematic block diagram illustrating a multi-image processing apparatus according to a first exemplary embodiment of the present invention;

FIG. 6 is a schematic block diagram illustrating a multi-image processing apparatus according to a second exemplary embodiment of the present invention;

FIG. 7 is a schematic block diagram illustrating a multi-image processing apparatus according to a third exemplary embodiment of the present invention;

FIG. 8 is a schematic view illustrating an image captured by a multi-image processing apparatus according to the third exemplary embodiment of present invention;

FIGS. 9a, 9b and 9c are schematic views illustrating an image distributed to a processing unit of the multi-image processing apparatus according to the third exemplary embodiment of present invention;

FIG. 10 is a schematic block diagram illustrating a multi-image processing apparatus according to a fourth exemplary embodiment of the present invention; and

FIG. 11 is a schematic view illustrating an image distributed to a processing unit of the multi-image processing apparatus according to the fourth exemplary embodiment of present invention.

### BEST MODE FOR CARRYING OUT THE INVENTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

Furthermore, “exemplary” is merely meant to mean an example, rather than the best.

It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted. Now, the present invention will be described in detail with reference to the accompanying drawings.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

Meanwhile, the terminology used herein is for the purpose of describing particular implementations only and is not intended to be limiting of the present disclosure. The terms “first,” “second,” and the like, herein do not denote any order, quantity, or importance, but rather are used to distinguish one element from another. For example, a second constituent element may be denoted as a first constituent element without departing from the scope and spirit of the present disclosure, and similarly, a first constituent element may be denoted as a second constituent element.

Now, the multi-image processing apparatus according to exemplary embodiments of the present invention will be described in detail with reference to the accompanying drawings.

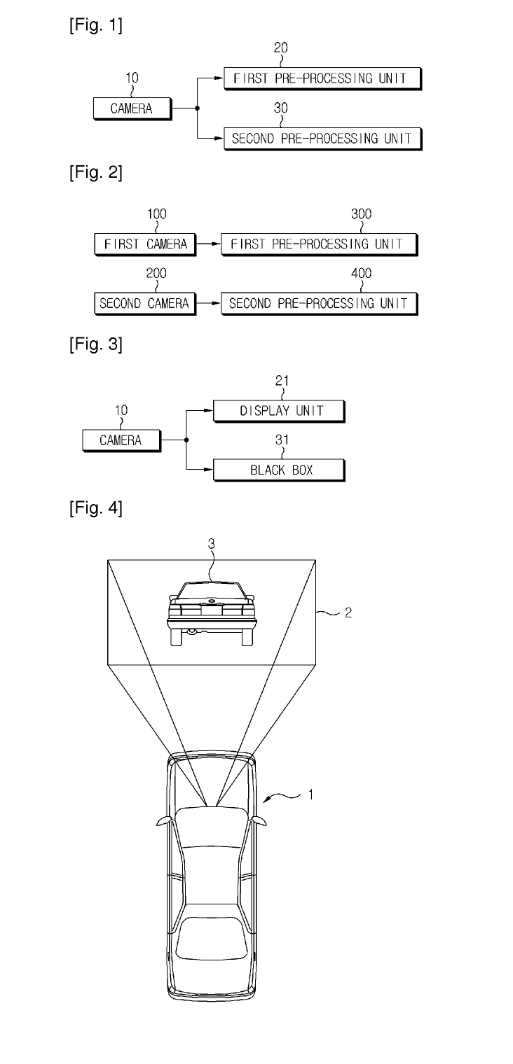

FIG. 1 is a schematic block diagram illustrating a multi-image processing apparatus according to the present invention, and FIG. 2 is a schematic block diagram explaining a comparative example according to the present invention.

The multi-image processing apparatus according to the present invention is such that an image of a subject captured by a single camera (10) is received by at least two processing units (20, 30) that perform mutually different image processing.

That is, as illustrated in FIG. 1, the multi-image processing apparatus according to the present invention includes a camera (10) photographing a subject, a first processing unit (20) processing an image of the subject by receiving the image captured by the camera (10), and a second processing unit (30) processing an image of the subject by receiving the image captured by the camera (10).

The image captured by the camera (10) is branched out and the branched-out images are respectively inputted to the first and second processing units (20, 30), where the first and second processing units (20, 30) perform mutually different image processing for the received images of the subject.

FIG. 2 is a schematic block diagram explaining a comparative example according to the present invention, where a first processing unit (300) must receive an image of a subject captured by a first camera (100) to perform an image process of the subject. Furthermore, a second processing unit (400) must receive an image of a subject captured by a second camera (200) to perform an image process of the subject.

Thus, the multi-image processing apparatus according to the present invention is such that an image of a subject captured by a single camera is divided, and each of the divided images is provided to each of a plurality of processing units that perform mutually different processing operations to advantageously reduce the number of cameras.

The multi-image processing apparatus according to the present invention is installed at a device needing several cameras to enable reduction in size of the device, reduced manufacturing cost of the device, reduced consumption of power and simplified wiring job.

FIG. 3 is a schematic block diagram illustrating a multi-image processing apparatus according to an exemplary embodiment of the present invention, and FIG. 4 is a schematic view illustrating an image captured by a multi-image processing apparatus mounted on a vehicle according to the present invention.

Referring to FIG. 3, a processing unit of the aforementioned multi-image processing apparatus may include a display unit (21) and a black box (31), for example. That is, in a case a multi-image processing apparatus according to the present invention is mounted on a vehicle, the camera (10) may be installed at any one place of a front side, a rear side and a lateral side of the vehicle, and the image of the subject captured by the camera (10) may be an image captured while the vehicle is travelling.

Referring to FIG. 4, in a case the camera (10) is installed at a front surface of a vehicle (1), for example, an image (2) captured by the camera (10) while the vehicle (1) is travelling includes a front vehicle (3) positioned at a front side of the vehicle (10). Thus, the image (2) of the subject captured by the single camera (10) installed at the vehicle may be displayed on the display unit (21) viewable by a driver inside the vehicle, or may be stored in the black box (31) capable of checking an image at the time of emergency or accident that occurs while the vehicle is travelling.

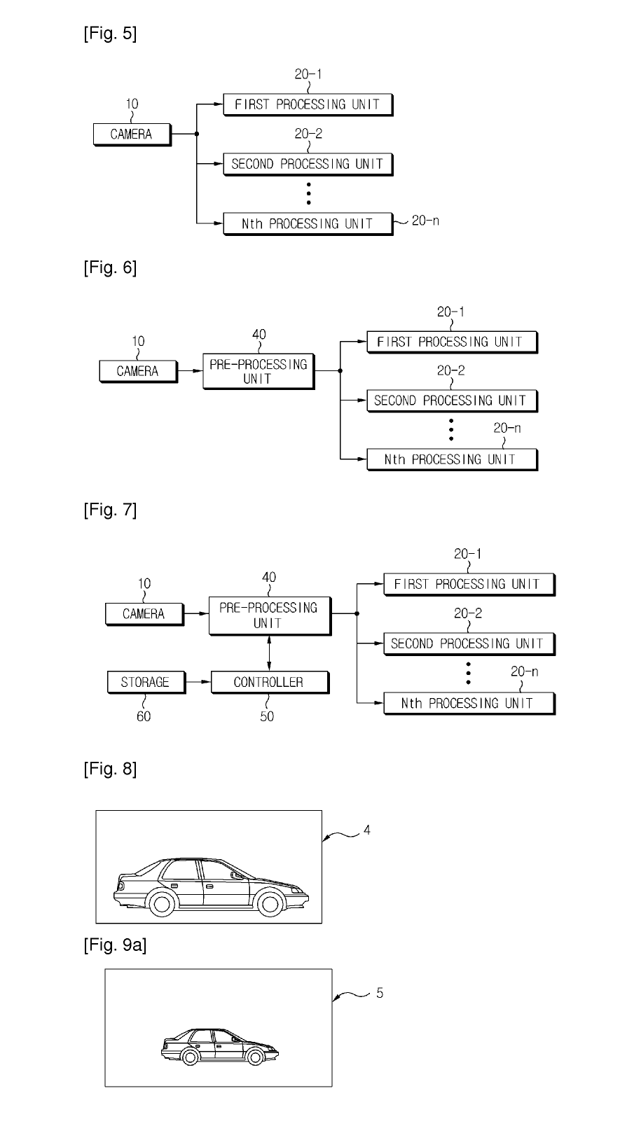

FIG. 5 is a schematic block diagram illustrating a multi-image processing apparatus according to a first exemplary embodiment of the present invention, FIG. 6 is a schematic block diagram illustrating a multi-image processing apparatus according to a second exemplary embodiment of the present invention, and FIG. 7 is a schematic block diagram illustrating a multi-image processing apparatus according to a third exemplary embodiment of the present invention.

Now, referring to FIG. 5, the multi-image processing apparatus according to a first exemplary embodiment of the present invention includes a camera (10) photographing a subject, and first to nth processing units (20) each capable of processing an image of the subject captured by the camera (10) by receiving the image of the subject captured by the camera (10), where the first to nth processing units (20) may perform mutually different image processing operations by being mounted on a vehicle.

Thus, the multi-image processing apparatus according to the present invention is such that an image of a subject captured by a single camera (10) is divided, and each of the divided images is provided to each of the first to nth processing units that perform mutually different unique processing operations to the received image of the subject.

### Mode for the Invention

Referring to FIG. 6, the multi-image processing apparatus according to the second exemplary embodiment of the present invention is such that an image of a subject captured by the camera (10) is inputted to a pre-processing unit (40), where the pre- processing unit (40) physically processes the received image of the subject, or extracts an attribute of the image of the subject and outputs the attribute to any one of the first to nth processing units (20).

At this time, the physical process of the image performed by the first pre-processing unit (40) may include one of enlargement, reduction and cutting of the image received from the camera. That is, the pre-processing unit (40) branches out the image of the subject or an enlarged image of the image of the subject, branches out the image of the subject or a reduced image of the image of the subject, or branches out the image of the subject or an image cut out of a particular area from the image of the subject.

Furthermore, the extraction of image attribute by the pre-processing unit (40) may includes brightness detection of the image, detection of an operating object, extraction of password and detection of speed of the object. That is, the pre-processing unit (40) may control the brightness detection of the image and other accessory devices (not shown) of a device installed with the multi-image processing apparatus of the present invention using the detection of an operating object and speed thereof, or certify using the password extracted from the image of the subject. Although the exemplary embodiment of the present invention has illustrated that the pre-processing unit (40) performs the physical processing operation and attribute extraction, the performance by the pre-processing unit (40) is not limited thereto, and a separate pre-processing unit may be installed to perform a physical processing operation and an attribute extraction.

Meanwhile, as illustrated in FIG. 7, the multi-image processing apparatus according to the third exemplary embodiment of the present invention is such that data related to the attribute extracted from the pre-processing unit (40) is stored in storage (60), where a controller (50) compares the attribute extracted from the pre-processing unit (40) with the data stored in the storage (60) to control the pre-processing unit (40), whereby the attribute extracted from the image of the subject distributed by the pre-processing unit (40) and the image of the subject physically processed by the pre-processing unit (40) are respectively transmitted to the first to nth processing units (20) by the controller (50).

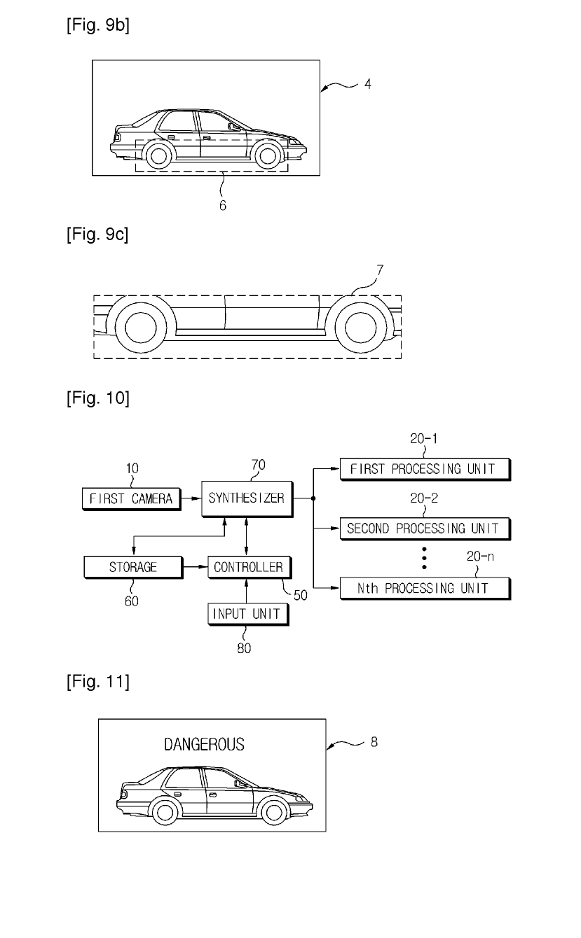

FIG. 8 is a schematic view illustrating an image captured by a multi-image processing apparatus according to the third exemplary embodiment of present invention, and FIGS. 9a, 9b and 9c are schematic views illustrating an image distributed to a processing unit of the multi-image processing apparatus according to the third exemplary embodiment of present invention.

The image captured by the camera of the multi-image processing apparatus according to the third exemplary embodiment of present invention, e.g., an image (4) of a lateral side of the vehicle captured as shown in FIG. 8, may be physically processed, or an image (5) is reduced as shown in FIG. 9a, or an image (7) may be enlarged as shown in FIG. 9c. At this time, it can be noted that the enlarged image (7) is an enlargement of a particular area (6) as illustrated in FIG. 9b.

FIG. 10 is a schematic block diagram illustrating a multi-image processing apparatus according to a fourth exemplary embodiment of the present invention and FIG. 11 is a schematic view illustrating an image distributed to a processing unit of the multi-image processing apparatus according to the fourth exemplary embodiment of present invention.

The multi-image processing apparatus according to a fourth exemplary embodiment of the present invention includes storage (60) storing a synthetic elements including an image, a character and a code synthesizable with the image of subject captured from the camera, and a synthesizer (70) synthesizing the image of subject received from the camera with any one of the synthetic elements including the image, the character and the code stored in the storage (60).

That is, the synthesizer (70) synthesizes the image of subject captured by the camera (10) with at least one or more synthetic elements including the image, the character and the code stored in the storage (60), and distributes to any one of the first to nth processing units (20).

For example, as shown in FIG. 11, in a case the camera (10) is mounted on a vehicle, the synthesizer (70) may output an image (8) in which the image captured by the camera (10) is synthesized with a warning character of “Dangerous”. Although the fourth exemplary embodiment of the present invention has illustrated the synthesizer (70) for convenience sake, it should be apparent to the skilled in the art that an image synthesizing function may be added to the pre-processing unit (40) according to the second and third exemplary embodiments of the present invention.

Furthermore, the multi-image processing apparatus according to the fourth exemplary embodiment of the present invention may further include an input unit (80) for a user to input data, where an input signal of the input unit (80) may be inputted into the controller (50), the controller (50) controls the synthesizer (70), or controls the synthesizer (70) so that the image of subject received from the camera can be synthesized with at least any one of the synthetic elements including the image, the character and the code stored in the storage (60).

Still furthermore, although the fourth exemplary embodiment of the present invention has illustrated, for convenience sake, that the storage (60) and the controller (50) according to the third exemplary embodiment of the present invention store synthetic elements synthesizable by the synthesizer (70), and the controller (50) controls the synthesizer (70), it should be apparent to the skilled in the art that storage and a controller are separately prepared to allow performing respectively different functions.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

The camera module according to the present invention has an industrial applicability in that an image of a subject captured by a single camera is branched out to be provided to a plurality of processing units capable of performing mutually different image processing, whereby the number of cameras can be reduced, and a single camera can be installed at a device needing several cameras to enable miniaturization of the device and reduction in cost, whereby power consumption can be reduced and wiring can be simplified.

1. A multi-image processing apparatus, the apparatus comprising: a camera capturing a subject to obtain an image; and a plurality of processing units receiving the image from the camera to respectively perform an image processing operation.

2. The apparatus of claim 1, further comprising a first pre-processing unit receiving the image from the camera to physically process the image.

3. The apparatus of claim 2, wherein at least one or more processing units in the plurality of processing units receive the image physically processed by the first pre-processing unit.

4. The apparatus of claim 2, wherein the physical process of the image performed by the first pre-processing unit includes one of enlargement, reduction and cutting of the image received from the camera.

5. The apparatus of claim 1, further comprising a second pre-processing unit receiving the image from the camera to extract an image attribute from the image.

6. The apparatus of claim 5, wherein at least one or more processing units in the plurality of processing units receive an attribute-extracted image and the attribute from the second pre-processing unit.

7. The apparatus of claim 5, further comprising a first storage storing a data related to the image attribute; and a first controller controlling the second pre-processing unit by comparing the image attribute extracted by the second pre-processing unit with a data related to an attribute stored in the first storage.

8. The apparatus of claim 5, wherein the extraction of image attribute includes at least one of brightness detection of the image, detection of an operating object, extraction of password and detection of speed of the object.

9. The apparatus of claim 1, further comprising a second storage storing a synthetic element synthesizable with the image received from the camera; and a synthesizer synthesizing the image received from the camera with the synthetic element stored in the second storage.

10. The apparatus of claim 9, wherein at least one or more processing units in the plurality of processing units receive the image synthesized by the synthesizer.

11. The apparatus of claim 9, further comprising a second controller controlling the synthesizer to synthesize the synthetic element stored in the second storage with the image received from the camera.

12. The apparatus of claim 1, wherein the camera and the plurality of processing units are mounted on a vehicle.
